(19) United States
(12) Patent Application Publication
(10) Pub. No.: US 2003/0084323 A1
(43) Pub. Date: May 1, 2003

(54) Network intrusion detection system and method

(76) Inventor: George S. Gales, Plano, TX (US)

Correspondence Address: HEWLETT-PACKARD COMPANY, Intellectual Property Administration, P.O. Box 272400, Fort Collins, CO, 80527-2400, US

(21) Appl. No.: 10/002,423

(22) Filed: Oct. 31, 2001

(51) Int. Cl. G06F 11/30

(52) U.S. Cl. 713/200

(57) ABSTRACT

A network intrusion detection system comprises a processor and a memory accessible by the processor. The system also comprises a monitor application stored in the memory and executable by the processor. The monitor application is adapted to monitor network activity associated with a network node. The system also comprises a profile application stored in the memory and executable by the processor. The profile application is adapted to automatically generate an activity profile associated with the network node using the monitored network activity. The system further comprises a recognition engine stored in the memory and executable by the processor. The recognition engine is adapted to compare a network event to the activity profile to determine whether the network event is authorized for the network node.

### CROSS-REFERENCE TO RELATED APPLICATIONS

This patent application is related to co-pending U.S. patent Application, Attorney Docket No. 10014010-1, entitled “METHOD AND COMPUTER READABLE MEDIUM FOR SUPPRESSING EXECUTION OF SIGNATURE FILE DIRECTIVES DURING A NETWORK EXPLOIT”; U.S. patent Application, Attorney Docket No. 10016933-1, entitled “SYSTEM AND METHOD OF DEFINING THE SECURITY CONDITION OF A COMPUTER SYSTEM”; U.S. patent Application, Attorney Docket No. 10017028-1, entitled “SYSTEM AND METHOD OF DEFINING THE SECURITY VULNERABILITIES OF A COMPUTER SYSTEM”; U.S. patent Application, Attorney Docket No. 10017029-1, entitled “SYSTEM AND METHOD OF DEFINING UNAUTHORIZED INTRUSIONS ON A COMPUTER SYSTEM”; U.S. patent Application, Attorney Docket No. 10016861-1, entitled “NODE, METHOD AND COMPUTER READABLE MEDIUM FOR INSERTING AN INTRUSION PREVENTION SYSTEM INTO A NETWORK STACK”; U.S. patent Application, Attorney Docket No. 10016862-1, entitled “METHOD, COMPUTER-READABLE MEDIUM, AND NODE FOR DETECTING EXPLOITS BASED ON AN INBOUND SIGNATURE OF THE EXPLOIT AND AN OUTBOUND SIGNATURE IN RESPONSE THERETO”; U.S. patent Application, Attorney Docket No. 10016591-1, entitled “NETWORK, METHOD AND COMPUTER READABLE MEDIUM FOR DISTRIBUTED SECURITY UPDATES TO SELECT NODES ON A NETWORK”; U.S. patent Application, Attorney Docket No. 10014006-1, entitled “METHOD, COMPUTER READABLE MEDIUM, AND NODE FOR A THREE-LAYERED INTRUSION PREVENTION SYSTEM FOR DETECTING NETWORK EXPLOITS”; U.S. patent Application, Attorney Docket No. 10016864-1, entitled “SYSTEM AND METHOD OF AN OS-INTEGRATED INTRUSION DETECTION AND ANTI-VIRUS SYSTEM”; U.S. patent Application, Attorney Docket No. 10002019-1, entitled “METHOD, NODE AND COMPUTER READABLE MEDIUM FOR IDENTIFYING DATA IN A NETWORK EXPLOIT”; U.S. patent Application, Attorney Docket No. 10017334-1, entitled “NODE, METHOD AND COMPUTER READABLE MEDIUM FOR OPTIMIZING PERFORMANCE OF SIGNATURE RULE MATCHING IN A NETWORK”; U.S. patent Application, Attorney Docket No. 10017333-1, entitled “METHOD, NODE AND COMPUTER READABLE MEDIUM FOR PERFORMING MULTIPLE SIGNATURE MATCHING IN AN INTRUSION PREVENTION SYSTEM”; U.S. patent Application, Attorney Docket No. 10017330-1, entitled “USER INTERFACE FOR PRESENTING DATA FOR AN INTRUSION PROTECTION SYSTEM”; U.S. patent Application, Attorney Docket No. 10017270-1, entitled “NODE AND MOBILE DEVICE FOR A MOBILE TELECOMMUNICATIONS NETWORK PROVIDING INTRUSION DETECTION”; U.S. patent Application, Attorney Docket No. 10017331-1, entitled “METHOD AND COMPUTER-READABLE MEDIUM FOR INTEGRATING A DECODE ENGINE WITH AN INTRUSION DETECTION SYSTEM”; U.S. patent Application, Attorney Docket No. 10017328-1, entitled “SYSTEM AND METHOD OF GRAPHICALLY DISPLAYING DATA FOR AN INTRUSION PROTECTION SYSTEM”; and U.S. patent Application, Attorney Docket No. 10017303-1, entitled “SYSTEM AND METHOD OF GRAPHICALLY CORRELATING DATA FOR AN INTRUSION PROTECTION SYSTEM”.

### BACKGROUND OF THE INVENTION

Computer security is a serious requirement, especially for computer systems connected to a network, such as a local area network (LAN) or a wide area network (WAN). The Internet poses a significant security risk. Thus, computer systems connected to the Internet may have an even greater for security measures. For example, a computer hacker might seek to obtain unauthorized access to a computer to tamper with or access programs, access proprietary or sensitive data, launch a process within the computer, or introduce a computer virus or a Trojan horse.

Present security techniques generally include restricting access to a computer or data residing in a database of the computer on a file by file or directory by directory basis. Existing security techniques may also limit access based on a person by person or group by group basis. Present virus or Trojan horse detection techniques generally include scanning existing files or received files for the presence of known code formats and files indicating that the computer has received infected code or files. However, these existing techniques are limited in their versatility and/or adaptability, for example, by merely denying access to files. Additionally, present virus detection techniques generally require routine updating to maintain a current virus detection system.

Additionally, because it is nearly impossible for present software products alone to always discern between suspicious or potentially harmful network usage and legitimate or acceptable network usage, the software products tend to err on the side of conservancy, thereby reporting relatively large quantities of network activities as possible intrusions or unauthorized network usage, sometimes referred to as “false-positives.” Therefore, a network administrator or other user must generally distinguish between true network attacks or intrusions from the “false-positive” alerts.

### SUMMARY OF THE INVENTION

In accordance with one embodiment of the present invention, a network intrusion detection system comprises a processor and a memory accessible by the processor. The system also comprises a monitor application stored in the memory and executable by the processor. The monitor application is adapted to monitor network activity associated with a network node. The system also comprises a profile application stored in the memory and executable by the processor. The profile application is adapted to automatically generate an activity profile associated with the network node using the monitored network activity. The system further comprises a recognition engine stored in the memory and executable by the processor. The recognition engine is adapted to compare a network event to the activity profile to determine whether the network event is authorized for the network node.

In accordance with another embodiment of the present invention, a method for intrusion detection comprises monitoring network activity associated with a network node for a predetermined time period and automatically generating an activity profile corresponding to the network node using the monitored network activity. The method also comprises identifying a network event associated with the network node and automatically determining whether the network event is authorized for the network node using the activity profile.

### BRIEF DESCRIPTION OF THE DRAWINGS

For a more complete understanding of the present invention and the advantages thereof, reference is now made to the following descriptions taken in connection with the accompanying drawings in which:

FIG. 1 is a block diagram illustrating a computer network system in accordance with an embodiment of the present invention;

FIG. 2 is a block diagram illustrating an intrusion detection system in accordance with an embodiment of the present invention; and

FIG. 3 is a flow chart illustrating a method for intrusion detection in accordance with an embodiment of the present invention.

### DETAILED DESCRIPTION OF THE DRAWINGS

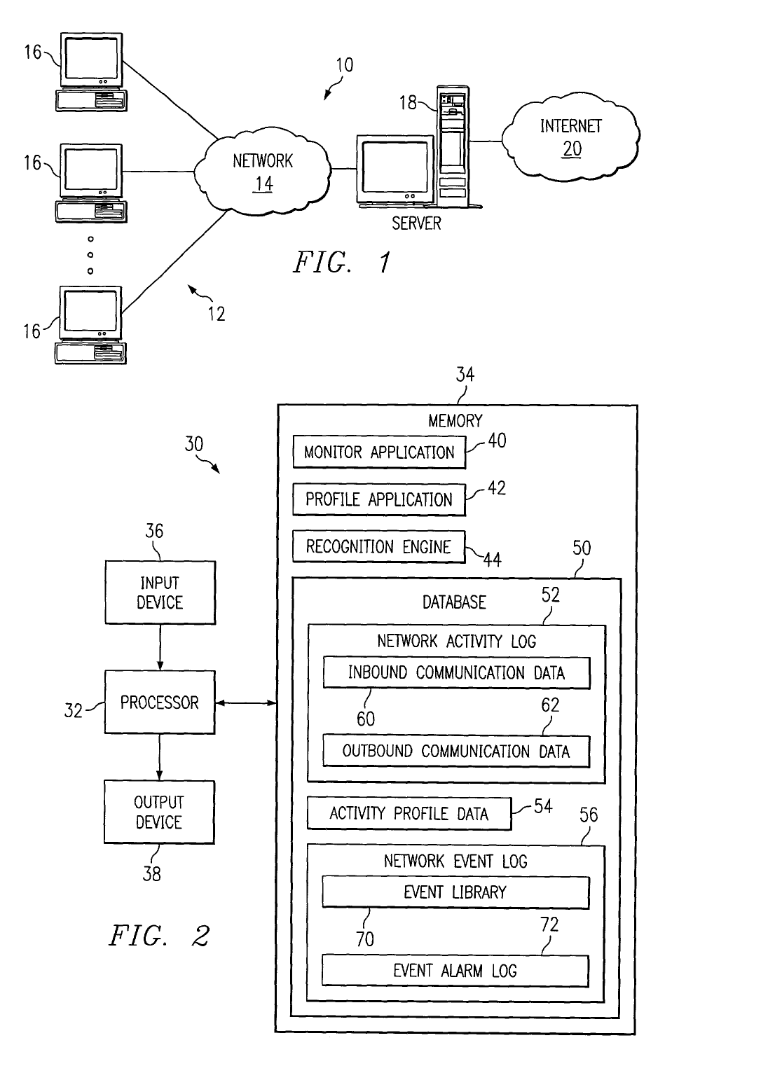

Embodiments of the present invention and the advantages thereof are best understood by referring to FIGS. 1 through 3 of the drawings, like numerals being used for like and corresponding parts of the various drawings.

FIG. 1 is a diagram illustrating a computer network 10 in accordance with an embodiment of the present invention. In the illustrated embodiment, the network 10 includes one or more network nodes 12 coupled to each other via an area network 14. The network nodes 12 may comprise user workstations 16 and/or a server 18 coupled to each other via the network 14. The network 14 may comprise a LAN, WAN or other network structure. The network 14 may also be coupled to the Internet 20 via the server 18 to enable access to the Internet 20 for each of the workstations 16. In accordance with the present invention, the risk of access to the server 18, network 14 and/or workstations 16 by a third party is substantially reduced or eliminated. Additionally, accessing applications, files, web sites, and other information by the workstations 16 that may adversely affect information security is also substantially reduced or eliminated.

FIG. 2 is a diagram illustrating an intrusion detection system 30 in accordance with an embodiment of the present invention. In the illustrated embodiment, the system 30 includes a processor 32 and a memory 34. The present invention also encompasses computer software that may be stored in memory 34 and executed by the processor 32. Data may be received from a user of the system 30 using a keyboard or any other type of input device 36. Results or data may be output through an output device 38, which may include a display, storage media, or any other type of output device. According to the present invention, the system 30 may be incorporated into or otherwise used in connection with the nodes 12 at the server 18, workstation 16, and/or other level of the computer network 10, such as each network interface card or other external or internal interface port.

The system 30 includes a monitor application 40, a profile application 42, and a recognition engine 44, which are computer software programs. In FIG. 2, the monitor application 40, profile application 42, and recognition engine 44 are illustrated as being stored in the memory 34, where they can be executed by the processor 32. However, the computer software programs may also be stored on various other types of computer-readable media accessible by the processor, including, without limitation, floppy disk drives, hard drives, CD ROM disk drives, or magnetic tape drives. Briefly, the monitor application 40 monitors network usage associated with each of the nodes 12. Using the established network usage patterns, the profile application 42 generates a network activity profile corresponding to each of the nodes 12. After the activity profiles have been generated, the recognition engine 44 compares future network events for a particular node 12 to the activity profile corresponding to the node 12. If the particular network event exceeds the activity profile for the node 12, the network event may be blocked, recorded, allowed, or otherwise processed.

The profile application 42 may also generate a network activity profile for the server 18. For example, in addition to providing services to the nodes 12, the server 18 may also be used to provide external access to information, such as web site hosting, file storage, external access to electronic mail or calendars, or third party access to other types controlled information. Based on established network usage patterns monitored by the monitor application 40, the activity profile corresponding to the server 18 may be used to determine whether particular network activities require blocking, recordation, or other processing.

The system 30 illustrated in FIG. 2 also includes a database 50. In the illustrated embodiment, the database 50 includes a network activity log 52, activity profile data 54, and a network event log 56. The network activity log 52 includes information associated with network usage for of the nodes 12 and/or the server 18. For example, the network activity log 52 may include inbound communication data 60 and outbound communication data 62. The inbound communication data 60 may include information associated with inbound data transfer to one of the nodes 12, from the Internet 18 or from another node 12, such as electronic mail receipt, file downloads, Internet 18 addresses and other Internet Protocol (IP) packet-related information, and other types of inbound data transfers. The data 60 may also include information associated with the date and time the connection was initiated or created, the duration of the connection, the protocols used, which or what kind of application accepted the data transfer, the quantity of data received, the bandwidth used, and other information associated with the inbound data transfer. Similarly, the data 60 may also include information corresponding to inbound data transfers associated with the server 18 from the nodes 12 or from the Internet 16.

The outbound communication data 62 similarly includes information associated with outbound data transfers from each of the nodes 12 and/or the server 18. For example, the outbound communication data 62 may include information associated with outbound data transfer to another node 12 or to the Internet 18, such as electronic mail transmissions, file transfers, IP packet-related information, or other types of data transfers. The outbound communication data 62 may also include information associated with usage of applications stored on or provided by the server 18. The information may include the date and time the connection was initiated or created, the duration of the connection, the protocols used, which application was used, which node 12 and/or user of the node 12 accessed the application, the quantity of data transferred, the bandwidth used, and other information associated with outbound data transfers. The data 62 may also include information associated with outbound data transfers from the server 18 to the nodes 12 or to the Internet 16.

The activity profile data 54 includes information associated with network usage patterns for each of the nodes 12 and/or the server 18. For example, using the inbound communication data 60 and the outbound communication data 62, an activity profile is generated for each of the nodes 12 and/or the server 18 representing the network usage pattern associated with a corresponding node 12 or server 18. In operation, future network activity for a particular node 12 and/or server 18 is compared with the activity profile corresponding to the node 12 or server 18 to determine whether the network activity is acceptable, unacceptable, or requires further or additional attention or processing.

The network event log 56 includes information associated with network events corresponding to the nodes 12 and/or server 18 that may not be otherwise reflected in the activity profile for the node 12 or server 18. For example, the network event log 56 may include an event library 70 and an event alarm log 72. The event library 70 may include information associated with acceptable network activity that may not be otherwise reflected in the activity profile data 54 for a particular node 12 and/or server 18. For example, the library 70 may include a listing of web sites, applications, or other network activities not reflected in the activity profile data 54 for a particular node 12 or server 18 but considered to be either acceptable network usage for the node 12 or server 18 or not an unauthorized network intrusion. New applications or information may be added to the library 70 by a network administrator or other user such that future network activity by the nodes 12 or server 18 is considered acceptable network usage without mistakenly indicating the network event as a possible unauthorized intrusion or unauthorized network usage.

The event alarm log 72 may include information associated with unknown network activity or usage corresponding to the nodes 12 and/or server 18. For example, the data 72 may include information associated with requested web site access by a node 12 or by a third party, repeated port number access by a third party, requested file or application access by a node 12 or by a third party, or other unknown or unrecognizable network activities indicative of unauthorized network access or usage. Information associated with a particular network event may be stored in the log 72 for future investigation and may also be used to automatically initiate security measures corresponding top the network event, such as generating an alarm via the output device 38, automatically blocking the network event, or other associated security measures.

In operation, the monitor application 40 monitors network traffic and/or usage associated with the nodes 12 and/or server 18 for a predetermined time period. The monitor application 40 stores the network usage and/or traffic information in the network activity log 52. In addition to being categorized under inbound communication data 60 and outbound communication data 62, the network usage and traffic information may be further categorized by the type of network usage, time and duration of usage, and other categorizations corresponding to particular types of network usage and traffic.

After monitoring the network traffic and usage patterns for the predetermined time period, the profile application 42 retrieves the network activity log 52 information and automatically generates an activity profile for the monitored nodes 12 and/or server 18 and stores the profile in the database 50 as the activity profile data 54. The activity profile may be generated based on the applications accessed and used, the web sites visited, the quantity of web sites visited, the quantity or addressees of electronic mail, the identities of third party access to web sites, or other network usage activities. Additionally, the activity profile data 54 may be updated on a substantially continuous or ongoing basis or may be updated in accordance with predefined time periods. For example, the activity profile data 54 may be updated on a daily, weekly, monthly or other predefined time period schedule. Further, the activity profile data 54 may be updated by examining the network activity during a variety of different time periods. For example, the activity profile data 54 may be updated based on the prior week's network activity, based on the prior month's network activity, or weekly based on the network activity corresponding to a particular month. The activity profile data 54 may also be automatically updated in response to a predetermined network event, such as a particular type of network activity. Accordingly, a variety of methods may be used to update the activity profile data 54.

After generation of the activity profiles for the nodes 12 and/or server 18, future network activity and usage is compared to the activity profile to determine whether particular network activities may be suspicious or potentially harmful activities. For example, the recognition engine 44 monitors network activity corresponding to the nodes 12 and/or server 18 and compares the network activity to the corresponding activity profile for the node 12 and/or server 18. If the network activity exceeds the activity profile, the recognition engine 44 automatically initiates security or other investigative measures to determine whether the particular network activity may be an unauthorized intrusion or other unauthorized network usage.

In one embodiment, the recognition engine 44 may access the event library 70 to determine if the particular network activity may be otherwise authorized network usage but not reflected in an activity profile for the particular node 12 or server 18. For example, the event library 70 may include a listing of applications hosted by the server 18, a listing of suitable web site addresses that may be accessed by the nodes 12, file or record access privilege information corresponding to the nodes 12 or third parties, a listing of third party protocols authorized to access a web site, or other network usage activities considered not to be unauthorized network usage or intrusions. Thus, although a particular network event may exceed an activity profile for the node 12 or server 18, the library 70 would indicate that the network event constitutes acceptable or authorized network usage, thereby substantially eliminating or reducing the quantity of “false-positive” network intrusion alerts.

If the library 70 indicates that the particular network event is authorized or not otherwise a network intrusion, the profile application 42 may be prompted to automatically update an activity profile corresponding to the network event. For example, if particular node 12 accesses an application hosted by the server 18 that has not been previously accessed by the node 12, the application may be listed in the library 70, thereby indicating that access to the application is acceptable network usage. The profile application 42 may then automatically update the activity profile corresponding to the node 12 to reflect the application access. Thus, the present invention continuously monitors and updates network usage and activity patterns to determine whether network events may constitute unauthorized usage or intrusion.

If the network event exceeds the activity profile for a node 12 or server 18, and the library 70 does not indicate that the network event is otherwise authorized, the recognition engine 44 may automatically store information associated with the network event in the event alarm log 72. For example, the stored information may include protocol information, the date, time and duration of the network connection, the application attempted to be accessed by the node 12 or third party, the identity of the node 12 or third party, or other information associated with the network event. The recognition engine 44 may also automatically perform or initiate security or precautionary measures directed toward the network event, such as blocking access to a requested application or web site, quarantining electronic mail, and/or generating an alarm or other type of alert signal to a network administrator notifying the administrator of the network event.

Thus, the present invention utilizes established network usage patterns to generate an activity profile corresponding to various connection or access points of the network. After activity profiles have been generated, future network activity may be compared to the activity profiles to determine whether the network activity constitutes unauthorized network usage or a network intrusion. Therefore, the present invention reduces the quantity of “false-positive” network intrusion or usage alerts. The present invention may also be configured to continuously monitor network usage patterns and automatically update activity profiles, thereby further decreasing the quantity of “false-positive” network alerts.

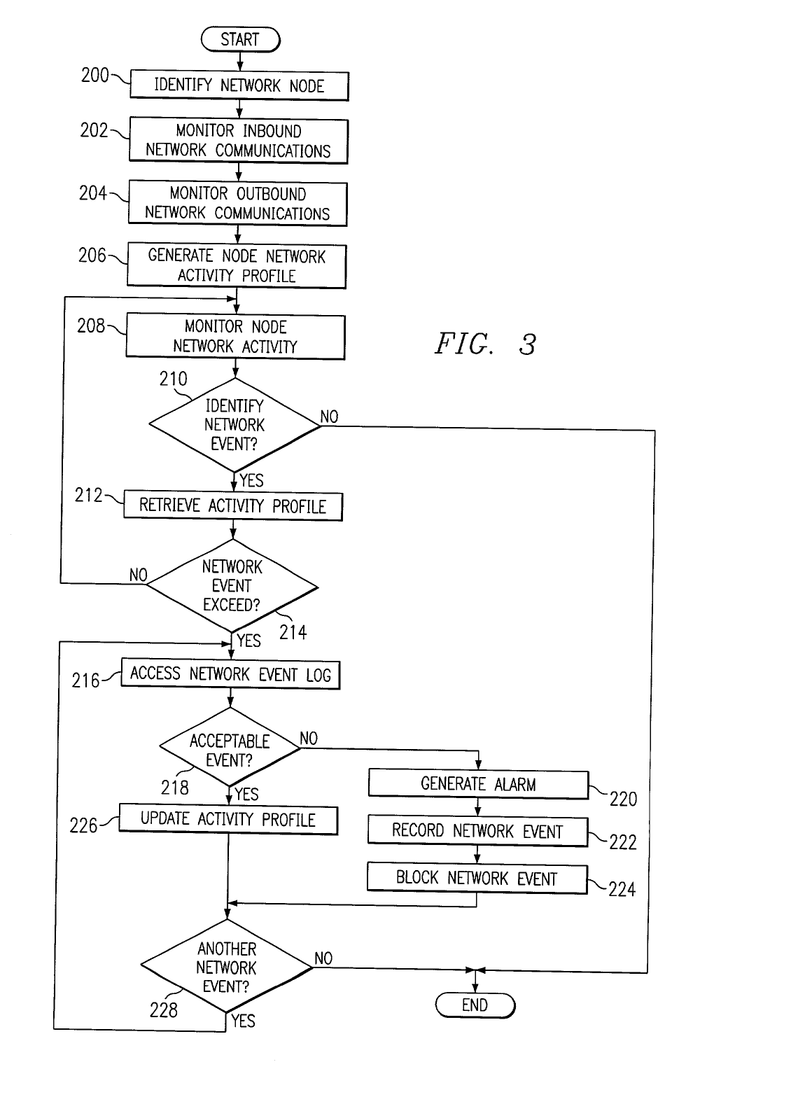

FIG. 3 is a flow chart illustrating a method for network intrusion detection in accordance with an embodiment and of the present invention. The method begins at step 200, where the monitor application 40 identifies a network node, such as one of the nodes 12 or the server 18. At step 202, the monitor application 40 monitors inbound network communications or traffic corresponding to the identified node, such as electronic mail receipt, data or file transfers, or other types of inbound information transfers. At step 204, the monitor application 40 monitors outbound network communications or traffic corresponding to the identified node, such as outbound electronic mail communications, web site access requests, data or file transfers, or other types of information transfer from the identified node.

After monitoring inbound and outbound network communications corresponding to the identified node for a predetermined time period, the profile application 42 automatically generates an activity profile corresponding to the identified node. At step 208, the recognition engine 44 continues to monitor network activity corresponding to the identified node. At decisional step 210, a determination is made whether the recognition engine 44 has identified a network event corresponding to the identified node. If a network event has been identified, the method proceeds to step 212, where the recognition engine 44 accesses or retrieves the activity profile data 54 corresponding to the identified node. At decisional step 214, the recognition engine 44 compares the network event to the activity profile corresponding to the identified node and determines whether the network event exceeds the corresponding activity profile. If the network event does not exceed the activity profile, the method returns to step 208. If the network event does exceed the activity profile, the method proceeds from step 214 to step 216, where the recognition engine 44 accesses or retrieves information contained in the event library 70.

At decisional step 218, the recognition engine 44 compares the network event to information contained in the event library 70 to determine whether the network event constitutes authorized or acceptable network access or usage. If the network event does not constitute authorized or acceptable network usage, the method proceeds from step 218 to step 220, where the recognition engine 44 generates an alarm to notify a network administrator of the particular network event. At step 222, the recognition engine 44 records or stores information associated with the network event in the event alarm log 72. At step 224, the recognition engine 44 automatically initiates security measures corresponding to the network event, such as blocking or restricting access to a requested file, website, or other network activity.

If the network event is considered to be an acceptable or authorized usage of the network at decisional step 218, the method proceeds from step 218, to step 226, where the profile application 42 automatically updates the activity profile corresponding to the identified node. The method then proceeds from step 226 to decisional step 228, where a determination is made whether another network event has occurred. If another network event has occurred, the method returns to step 216.

What is claimed is:

1. A network intrusion detection system, comprising:
a processor;
a memory accessible by the processor;
a monitor application stored in the memory and executable by the processor, the monitor application adapted to monitor network activity associated with a network node;
a profile application stored in the memory and executable by the processor, the profile application adapted to automatically generate an activity profile associated with the network node using the monitored network activity; and
a recognition engine stored in the memory and executable by the processor, the recognition engine adapted to compare a network event to the activity profile to determine whether the network event is authorized for the network node.

2. The system of claim 1, wherein the network activity comprises inbound data communications and outbound data communications.

3. The system of claim 2, wherein the inbound and outbound data communications comprise electronic mail communications.

4. The system of claim 2, wherein the inbound and outbound data communications comprise Internet communications.

5. The system of claim 1, wherein the profile application generates the activity profile corresponding to network activity occurring over a predetermined time period.

6. The system of claim 1, wherein the profile application is further adapted to automatically update the activity profile in response to a predetermined event.

7. The system of claim 1, wherein the profile application is further adapted to automatically update the activity profile corresponding to a predetermined time period.

8. The system of claim 1, wherein the recognition engine is further adapted to block the network event if the network event exceeds the activity profile.

9. The system of claim 1, wherein the profile application is further adapted to automatically update the activity profile if the network event is authorized.

10. The system of claim 1, further comprising an event library accessible by the recognition engine to determine whether the network event is authorized, the event library comprising information associated with authorized network activities not reflected in the activity profile.

11. A method for network intrusion detection, comprising:
monitoring network activity associated with a network node for a predetermined time period;
automatically generating an activity profile corresponding to the network node using the monitored network activity;
identifying a network event associated with the network node; and
automatically determining whether the network event is authorized for the network node using the activity profile.

12. The method of claim 11, wherein monitoring the network activity comprises monitoring inbound data communications and outbound data communications associated with the network node.

13. The method of claim 11, wherein monitoring the network activity comprises monitoring network application usage corresponding to the network node.

14. The method of claim 11, further comprising accessing an event library to determine whether the network event is authorized, the event library comprising information associated with authorized network activities not reflected in the activity profile.

15. The method of claim 11, further comprising automatically updating the activity profile if the network event is authorized.

16. The method of claim 11, further comprising automatically blocking the network event if the network event is not authorized.

17. The method of claim 11, further comprising automatically updating the activity profile in response to a predetermined network event.

18. The method of claim 11, further comprising automatically updating the activity profile corresponding to a predetermined time period.

19. A network detection intrusion system, comprising:
a plurality of nodes coupled to a server via a network;
a monitoring application accessibly by the server and adapted to monitor network activity between the plurality of nodes;
a profile application accessible by the server and adapted to generate an activity profile for each of the plurality of nodes; and
a recognition engine accessible by the server and adapted to compare a network event corresponding to one of the plurality of nodes to the activity profile corresponding to the one node to determine whether the network event is authorized for the one node.

20. The system of claim 19 wherein the profile application is further adapted to automatically update the activity profile corresponding to the one node if the network event is authorized.

21. The system of claim 19 wherein the monitoring application is adapted to monitor inbound data communications and outbound data communications associated with each of the nodes.

22. The system of claim 19 further comprising an event library accessible by the server to determine whether the network event is authorized, the event library comprising information associated with authorized network activities not reflected in the activity profile for the one node.

23. The system of claim 19 wherein the monitoring application is adapted to monitor network application usage for each of the nodes.

24. The system of claim 19 wherein the recognition engine is further adapted to generate an event alarm log for the network event if the network event is not authorized.

25. The system of claim 19, wherein the profile application is further adapted to automatically update the activity profile for each of the nodes corresponding to a predetermined time period.

26. The system of claim 19, wherein the profile application is further adapted to automatically update an activity profile corresponding to a node in response to a predetermined network event corresponding to the node.

27. A computer program for assisting in network intrusion detection, comprising:
a computer-readable medium; and
a profile application stored on the computer-readable medium, the profile application adapted to monitor network activity and generate an activity profile using the monitored network activity, the activity profile used to determine whether a network event is authorized.

28. The computer program of claim 27, wherein the profile application is configured to automatically update the activity profile in response to a predetermined network event.

29. The computer program of claim 27, wherein the profile application is further configured to automatically update the activity profile corresponding to a predetermined time interval.

30. The computer program of claim 27, further comprising a recognition engine stored on the computer-readable medium and adapted to compare the network event to the activity profile.

31. The computer program of claim 27, wherein the profile application is adapted to monitor inbound data communications and outbound data communications corresponding to the network.

32. The computer program of claim 27, further comprising a recognition engine adapted to compare the network event to the activity profile and block the network event if the network event exceeds the activity profile.

33. The computer program of claim 27, wherein the profile application generates the activity profile corresponding to network activity occurring over a predetermined time period.
